(19) United States
(12) Patent Application Publication
(10) Pub. No.: US 2012/0047423 A1
(43) Pub. Date: Feb. 23, 2012

(54) VIRTUAL HTML ANCHOR

(75) Inventor: Terrance A. Tomkow, Los Angeles, CA (US)

(73) Assignee: RMAIL LIMITED, Pembroke (BM)

(21) Appl. No.: 13/187,318

(22) Filed: Jul. 20, 2011

Related U.S. Application Data
(60) Provisional application No. 61/366,113, filed on Jul. 20, 2010.

(51) Int. Cl. G06F 17/00; G06F 15/16

(52) U.S. Cl. 715/205

(57) ABSTRACT

A method allowing a reader of a document who is not the author of the document to reference and link to some specific portion or location in the document so that others may navigate directly to the specific portion of the document even where the author of the document has not provided an HTML anchor to the specific portion or location of the document is provided.

### CROSS-REFERENCES TO RELATED APPLICATIONS

This application claims priority from U.S. Application No. 61/366,113, filed Jul. 20, 2010, which is hereby incorporated by reference in its entirety.

### FIELD OF THE INVENTION

The present invention relates generally to hyperlinks and anchor text in hypertext markup language (HTML), internet browsers which are software programs which allow users to view documents over the Internet and internet servers which transmit documents for viewing over the internet.

### BACKGROUND OF THE INVENTION

One of the key useful features of HyperText Markup Language (HTML) used to create HTML documents is that an HTML document may contain references or links not just to other documents but to specific locations in other documents. An HTML link or “hyperlink” is created by the author of a source HTML document using an HTML anchor element A to allow readers to jump to the location of the anchor in that document. These locations are sometimes called “bookmarks.” When selected by the reader, such as, for example, by clicking on the hyperlink with a mouse, the HTML browser is signaled to navigate to the location of the anchor in the other document.

Anchors in HTML documents are specified by HTML markup elements. An anchor element A also allows the author to name or label various sections of the HTML document so that links can reference the specific sections of the HTML document on other web pages. Internet search engines will often provide links to the named anchors in an internet web page as well as the document itself.

A link to an HTML anchor in a page includes i) the internet Address (URL) of the page in which the anchor occurs and ii) a query (“?”) parameter which signals the browser processing the link to search for and display an anchor in the page and identifier of the particular anchor to be located.

Anchors offer clear advantages in allowing users to navigate to particular points within documents presented on the internet. However they are limited insofar as consumers of the pages must rely on the author of the document to have placed anchors at points of interest within the document. These may not be locations which interest a reader and may be absent altogether particularly when a large document has been imported from other media into an internet readable form.

A reader of an HTML document who is not the author of the document may wish to reference and link to some specific portion or location in a document so that others may navigate directly to the relevant section of the referenced document even when the author of that document has not provided HTML anchors to that section.

What has been needed, and heretofore unavailable, is a system and method which allows any reader of any internet document to create a link to any selected point in the document and make that link available to others to allow them to navigate directly to that location. Such a system or method would allow readers to set “virtual anchors” in third party internet pages. The present invention provides these and other advantages.

### SUMMARY OF THE INVENTION

In a general aspect, the present invention is directed to a method allowing a reader of a document who is not an author of the document to create one or more virtual links to some specific location or locations within the document so that others may navigate directly to the specific location or locations within the document even when the author of the document has not provided a link to the specific location. In a more detailed aspect, the present invention includes retrieving a document not authored by the reader from a memory associated with a server; displaying the retrieved document to the reader; identifying a specific location selected by the reader within the displayed document; adding an indication at the specific location selected by the reader within the displayed document to the displayed document, the indication being recognizable by software commands executed within a browser to form a hyperlink to the specific location of the document which can be used by the reader or any other reader to access the specific location selected within the displayed document; and transmitting the document, including the added indication, to the memory associated with the server such that the document, including the added indication, is available for retrieval by other readers.

In another aspect, the indication is a virtual anchor. In an alternative aspect, the hyperlink is a parameterized HTML URL address string. In still another aspect, the indication indicates a starting point and an ending point identifying a selected portion of the document.

In still another aspect, the invention includes retrieving a document not authored by the reader from a memory associated with a source server; displaying the retrieved document to the reader; identifying a specific location selected by the reader within the displayed document; adding an indication at the specific location selected by the reader within the displayed document to the displayed document; calculating the location of the indication within the document; forming a hyperlink element from the calculated location, the hyperlink being usable by the reader or other readers to navigate to the specific location within the displayed document; and attaching the hyperlink element to the displayed document such that the hyperlink is available to other readers who retrieve the document from the memory associated with the server.

In yet another aspect, the indication is a virtual anchor. In an alternative aspect, the hyperlink is generated by software commands executed in the browser. In another alternative aspect, the indication is transmitted by the browser to a remote server which creates the hyperlink. In still another alternative aspect, the indication indicates a starting point and an ending point identifying a selected portion of the document.

In a further aspect, the hyperlink contains a link to a document viewable on the internet and locating information such that any browser with software capable of interpreting the hyperlink may navigate to a web page containing the document and use the locating information to navigate to the indicated location on the web page.

In another further aspect, the invention includes forming a hyperlink includes incorporating a link to a server which may be different from the source server in the hyperlink. In yet another aspect, the invention includes retrieving at least a portion of the document from the source server by the server; calculating the indicted location; and transmitting the at least a portion of the document including the calculated location to a browser.

In yet another aspect, the invention includes retrieving at least a portion of the document from the source server by the server; adding an HTML anchor to the retrieved at least a portion of the document, the HTML anchor cooperating with a browser to display the calculated location within a displayed document. In still another aspect, the invention includes storing at the server at least a portion of the at least a portion of the document retrieved from the source server.

In still another aspect, the invention includes a method for a reader of a document who is not an author of the document to create a virtual link to some specific location in the document so that others may navigate directly to the specific location in the document even when the author of the document has not provide a link to the specific location, comprising: retrieving a document not authored by the reader from a memory associated with a server; displaying the retrieved document to the reader; identifying a specific location selected by the reader within the displayed document; adding an indication at the specific location selected by the reader within the displayed document to the displayed document, the indication being recognizable by software commands executed within a browser to form a hyperlink to the specific location of the document which can be used by the reader or any other reader to access the specific location selected within the displayed document; and storing the hyperlink to a memory not associated with the server such that the document stored in the memory associated with the server is not changed, but the hyperlink may be used by other readers to retrieve the document from the memory associated with the server and display the retrieved document at the location indicated by the indication.

In still another aspect, the invention includes a method for a reader of a document who is not an author of the document to create a virtual link to some specific location in the document so that others may navigate directly to the specific location in the document even when the author of the document has not provide a link to the specific location, comprising: retrieving a document not authored by the reader from a memory associated with a source server; displaying the retrieved document to the reader; identifying a specific location selected by the reader within the displayed document; adding an indication at the specific location selected by the reader within the displayed document to the displayed document; calculating the location of the indication within the document; forming a hyperlink element from the calculated location, the hyperlink being usable by the reader or other readers to navigate to the specific location within the displayed document; and storing the hyperlink element in a memory other than the memory associated with the server such that the hyperlink is available to other readers.

In a further aspect, the invention includes a system configured to allow a user to a bookmark in an HTML document created by an author who is someone other than the user, the document being stored on a server remote from the user, comprising: a client computer having a processor and a display; a memory in operable communication with the processor of the client computer; a network connection configured to enable communication between the client computer and a server remote from the client computer; and wherein the processor of the client computer is configured to retrieve an original document created by an author other than a user of the system stored on the server remote from the client computer and display the retrieved document on the display of the client computer, the processor also configured to accept an input indicating a specific location in the displayed document from the user and to store a link containing information related to the specific location in the displayed document, the link not being added to the original document.

In a still further aspect, the link may be used to retrieve the document from the server and display the document at the specific location of the document identified by the indication. In yet another aspect, the link is a virtual anchor. In another aspect, the link is a parameterized HTML URL address string. In still another aspect, the link indicates a starting point and an ending point identifying a selected portion of the document.

In yet another aspect, the hyperlink contains a link to a document viewable on the internet and locating information such that any browser with software capable of interpreting the hyperlink may navigate to a web page containing the document and use the locating information to navigate to the indicated location on the web page.

Other features and advantages of the invention will become apparent from the following detailed description, taken in conjunction with any accompanying drawings, which illustrate, by way of example, the features of the invention.

### BRIEF DESCRIPTION OF THE DRAWINGS

FIG. 1 is schematic diagram illustrating a network of servers and clients using the Internet to create and view HTML document in accordance with principles of the present invention.

FIG. 2 is a graphical representation of an HTML web page presented in the form created by the author of the web page.

FIG. 3 is a graphical representation of the HTML web page of FIG. 2, showing a link created by a viewer of the web page who is not the creator of the web page, which link will be available to a second viewer of the web page to whom the first viewer has sent the web page.

### DETAILED DESCRIPTION OF THE PREFERRED EMBODIMENTS

Systems and methods for the generation of virtual anchors in browsed web sites are disclosed. It should be appreciated the present invention can be implemented in numerous ways, including as a process, an apparatus, a system, a device, a method, or a computer readable medium such a computer readable storage medium or a computer network wherein program instructions are sent over optical or electronic communication lines. Several inventive embodiments of the present invention are described below.

The method generally requires the selection by a user of some location, object or span of text in a source document or web page displayed in an internet browser. Software associated with or included in the internet browser generates—or transmits to a server which generates—information about the location of the selection. The information is converted to a link which may be used to navigate to the user selected location either by using client or server side software which can interpret said links. The effect is to allow a viewer of a document to create “virtual anchor” links to specific locations or sections of a viewed document.

The Internet is a worldwide decentralized network of computers having the ability to communicate with each other. The Internet has gained broad recognition as a viable medium for communicating and interacting across multiple networks. The World Wide Web (Web) was created in the early 1990's and is comprised of server-hosting computers (Web servers) connected to the Internet that have hypertext documents or Web pages stored therewithin. Web pages are accessible by client programs, such as, for example, Web browsers utilizing, for example, the Hypertext Transfer Protocol (HTTP) via a Transmission Control Protocol/Internet Protocol (TCP/IP) connection between a client-hosting device and a server-hosting device. While HTTP and hypertext documents are the prevalent forms for the Web, the Web itself refers to a wide range of protocols including Secure Hypertext Transfer Protocol (HTTPS), File Transfer Protocol (FTP), Gopher, and content formats including plain text, Extensible Markup Language (XML), as well as image formats such as Graphics Interchange Format (GIF) and Joint Photographic Experts Group (JPEG) and others known to those skilled in the art.

Specific to the Web, a Web server is a computer program (housed in a computer) that serves requested Web pages and files. A Web client is a requesting program associated with a user. A Web browser is an exemplary Web client for use in requesting Web pages and files from Web servers.

A Web site is conventionally a collection of Web pages and files related to a particular subject that includes a beginning file called a home page. A large Web site may reside on a number of geographically-dispersed Web servers.

As is known to those skilled in the art, a Web page is conventionally formatted via a standard page description language such as HyperText Markup Language (HTML), which typically contains text and graphics references and can reference sound, animation (e.g., via programs and/or scripts), and video data. HTML provides for basic document formatting and allows a Web content provider to specify hypertext links (typically manifested as highlighted text) to other Web servers and files. When a user selects a particular hypertext link, a Web browser reads and interprets an address, called a Uniform Resource Locator (URL) associated with the link, connects the Web browser with the Web server at that address, and makes an HTTP request for the file identified in the link. The Web server then sends the requested file to the client in HTML format which the Web browser interprets and displays to the user.

Exemplary Web browsers include Netscape Navigator® (Netscape Communications Corporation, Mountain View, Calif.) and Internet Explorer® (Microsoft Corporation, Redmond, Wash.). Web browsers typically provide a graphical user interface for retrieving and viewing information, applications and other resources hosted by Web servers.

As will be appreciated by one of skill in the art, the present invention may be embodied as a method, data processing system, or computer program product. Accordingly, the present invention may take the form of an entirely hardware embodiment, an entirely software embodiment, or an embodiment combining software and hardware aspects. Furthermore, the present invention may take the form of a computer program product on a computer-usable storage medium having computer-usable program code means embodied in the medium. Any suitable computer readable medium may be utilized including hard disks, CD-ROMs, optical storage devices, or magnetic storage devices.

Computer program code for carrying out operations of the present invention is preferably written in an object oriented programming language such as JAVA®, Smalltalk or C++. However, the computer program code for carrying out operations of the present invention may also be written in conventional procedural programming languages, such as, for example, the “C” programming language, or in a functional (or fourth generation) programming language such as Lisp, SML, or Forth. The program code may execute entirely on a web server, or it may execute partly on a web server and partly on a remote computer (i.e., a user's web client). In the latter scenario, the remote computer may be connected to the web server through a LAN or a WAN, or the connection may be made to an external computer, such as, for example, through the Internet using an Internet Service Provider.

The present invention is described below with reference to methods, apparatus (systems), and computer program products according to an embodiment of the invention. It will be understood that the various embodiments of the present invention can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in following description.

These computer program instructions may also be stored in a computer-readable memory that can direct a computer or other programmable data processing apparatus to function in a particular manner, such that the instructions stored in the computer-readable memory produce an article of manufacture including instruction means which implement the function or functions specified in the description of the various embodiments of the invention described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the description of the various embodiments of the invention described herein.

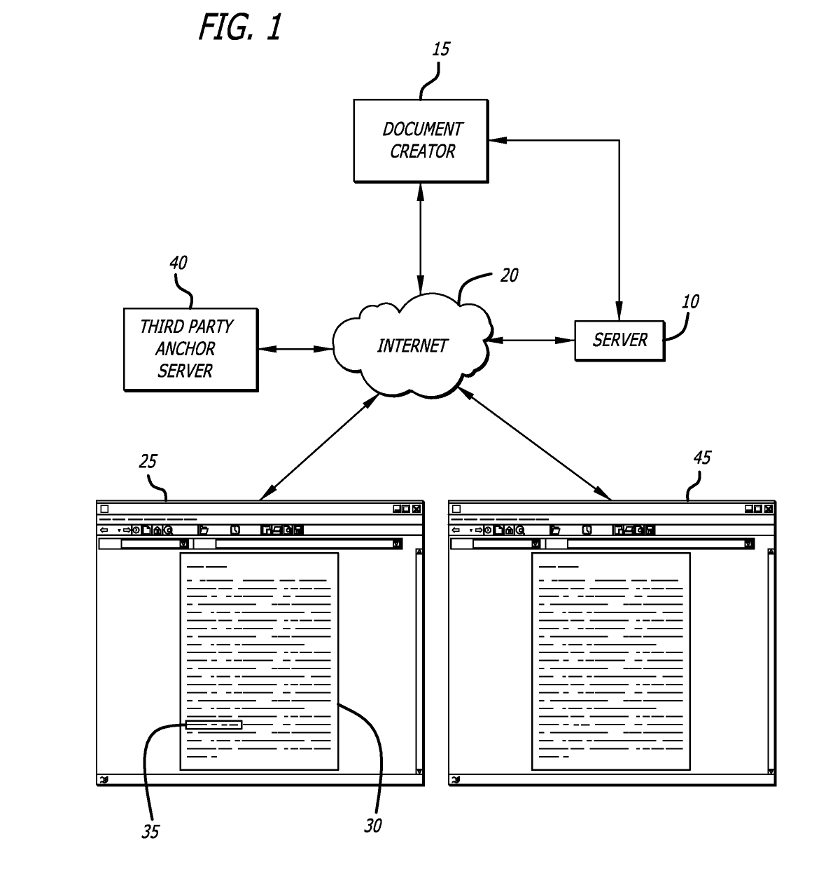

Referring now to FIG. 1, initially, a Web server 10 receives a user request for a Web page created by a document creator 15. The web page is stored by the document creator 15 on the Web server 10, either directly, or via the Internet 20. The user request is generated using a Web client 25 in communication with the Web server 10 over the Internet 20. The Web server then typically dynamically generates the requested Web page using a template and one or more content objects, although other methods are known to and used by those skilled in the art. Each content object used to generate the requested Web page generally has a unique identifier associated therewith. The generated Web page 30 is then served to the Web client 25 over the user's network, such as, for example, the Internet 20.

When the user receives the Web page 30 on the client 25, the user is able to view the contents of the document. Note that the user does not “own” the document, that is, he is not the author or creator of the document.

Often, however, the user may want to identify a portion of the Web page 30 as having particular interest for the user, and my want to transmit the document to another user. Previously, there was no way of sending the document to another user without making a change in the document, that is, the web page 30, and then saving the changed document back onto the server 10. Typically, however, most systems prevent saving changes made to Web pages by anyone other than the original creator, or persons that have been given expression permission to make such changes by the creator of the document displayed as the web page.

One embodiment of the present invention includes a method that involves a system which extends the system of HTML URL parameters used to generate and format the Web page to include a style of parameter which instructs the browser, or software associated with the browser, or the remote Internet server 20 providing the document at the identified by the requested URL (uniform resource locator), to navigate to a unique location 35 in the document based upon information included in the parameter even though that location may not have been marked in any distinctive way in the source document. The selection may also be distinctively displayed, such as, by example, using bold or colored characters. In FIG. 1, such a selection is shown having a box or color band surrounding the marked text in the Web page 30.

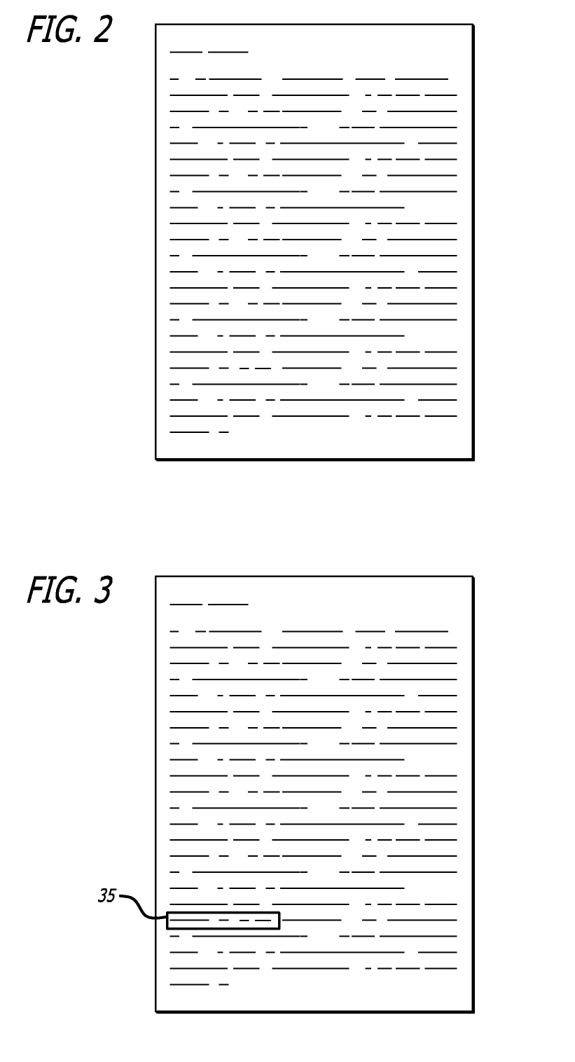

FIG. 2 illustrates a document, displayed as a Web page that has been retrieved from server 10. The document will typically contain various types of content, such as text, graphics and the like. When the user determines a specific location in the document that is of interest, the user then enables a tool of the software operating on the user's client 25 to insert an HTML tag or other information string at the desired location.

For example, the user places the cursor of the client system at the desired location of the document, and the user initiates the marking, such as, for example, by highlighting and clicking on selected text, or by clicking at a desired location in the document, the software operating on the client places an HTML code in the document which includes information sufficient to locate that location in the document. The information related to the desired location in the document is then communicated to a third party server 40 through a network, such as the Internet 20, where the location in the document is stored. FIG. 3 illustrates a portion 35 of the text of the retrieved document that has been marked by the user to indicate a desired location in the document.

Such information related to the desired location in the document may consist of a string of characters or symbols which has been calculated to occur only once in the document and which begins the selection, together with an indication of the length of the selection or a unique character string which marks the termination of the selection.

Alternatively the parameter may indicate a string or phrase which occurs more than once in the document and include an enumerator N which indicates that it is the N′th occurrence of the phrase that has been selected. Alternatively the parameter may indicate at least a pair of numbers S and F which represent the count in characters from the start or a boundary of the document to the beginning of the selection and a second number indicating the length of the selection. Other methods for uniquely identifying locations exist and/or could easily be devised and could be incorporated into this system and method.

A system of such URL parameters would allow the creation of client side or server side software that could create parameter strings pointing to portions of documents selected by users or by automated systems.

For example, in another embodiment, the software embodied in the programming commands operating on the user's client 25 calculates information sufficient to uniquely individuate the selected portion of the page and transmits this information to server 40, together with an identifying label for the location, with such server being remote from the user where information is recorded. The remote server 40 uses this information to create a link which is returned to, or made available for later retrieval, to the user.

The user may then include this link as a hyperlink in another HTML document that is either created or not created by the user. The user may then send either the HTML document, or a link to that document, to a second user who is using a client 45 to access documents stored on servers in communication with the Internet 20. When the second user clicks on the link, the second user's client is directed to server 40, which will use the parameters passed in the link to look up the original document and send it to the second user's browser, dynamically reformatting the document en route so that will appear at the second user's browser containing an HTML anchor to the selected location in the document.

The advantage of this embodiment is that it does not require the second user who references the link in the retrieved document to have any special browser software operating on client 45 beyond that required to navigate traditional HTML anchors.

In yet another embodiment, a computer program in the form of an internet browser or browser plug-in, allows the user to select a portion of a source document to create a virtual anchor to that location. The source document may be an HTML, text, a postscript, Portable Document Format (PDF), PowerPoint, Word or excel document, video or flash presentation or a graphic image. Once selected the browser records the address of the active page together with information which individuates the selected portion of the page. The browser uses these parameters to create a parameterized HTML URL address string which is made available to the user for copying and embedding in other html documents. When others click on this navigation link using a browser capable of interpreting these parameters, that browser will automatically take the user to the source page document and navigate to the selected location.

The advantage of this embodiment is that it allows for a browser to create virtual anchors without any special actions being taken on a server remote from the user and said anchors may be used by any other user with a browser capable of interpreting the locating parameters.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims.

I claim:

1. A method for a reader of a document who is not an author of the document to create a virtual link to some specific location in the document so that others may navigate directly to the specific location in the document even when the author of the document has not provide a link to the specific location, comprising:
retrieving a document not authored by the reader from a memory associated with a server;
displaying the retrieved document to the reader;
identifying a specific location selected by the reader within the displayed document;
adding an indication at the specific location selected by the reader within the displayed document to the displayed document, the indication being recognizable by software commands executed within a browser to form a hyperlink to the specific location of the document which can be used by the reader or any other reader to access the specific location selected within the displayed document; and
storing the hyperlink to a memory not associated with the server such that the document stored in the memory associated with the server is not changed, but the hyperlink may be used by other readers to retrieve the document from the memory associated with the server and display the retrieved document at the location indicated by the indication.

2. The method of claim 1, wherein the indication is a virtual anchor.

3. The method of claim 1, wherein the hyperlink is a parameterized HTML URL address string.

4. The method of claim 1, wherein the indication indicates a starting point and an ending point identifying a selected portion of the document.

5. A method for a reader of a document who is not an author of the document to create a virtual link to some specific location in the document so that others may navigate directly to the specific location in the document even when the author of the document has not provide a link to the specific location, comprising:
retrieving a document not authored by the reader from a memory associated with a source server;
displaying the retrieved document to the reader;
identifying a specific location selected by the reader within the displayed document;
adding an indication at the specific location selected by the reader within the displayed document to the displayed document;
calculating the location of the indication within the document;
forming a hyperlink element from the calculated location, the hyperlink being usable by the reader or other readers to navigate to the specific location within the displayed document; and
storing the hyperlink element in a memory other than the memory associated with the server such that the hyperlink is available to other readers.

6. The method of claim 5, wherein the indication is a virtual anchor

7. The method of claim 5, wherein the hyperlink is generated by software commands executed in the browser.

8. The method of claim 5, wherein the indication is transmitted by the browser to a remote server which creates the hyperlink.

9. The method of claim 5, wherein the indication indicates a starting point and an ending point identifying a selected portion of the document.

10. The method of claim 5, wherein the hyperlink contains a link to a document viewable on the internet and locating information such that any browser with software capable of interpreting the hyperlink may navigate to a web page containing the document and use the locating information to navigate to the indicated location on the web page.

11. The method of claim 1, wherein forming a hyperlink includes incorporating a link to a server which may be different from the source server in the hyperlink.

12. The method of claim 11, further comprising retrieving at least a portion of the document from the source server by the server;
calculating the indicted location; and
transmitting the at least a portion of the document including the calculated location to a browser.

13. The method of claim 7, further comprising retrieving at least a portion of the document from the source server by the server;
adding an HTML anchor to the retrieved at least a portion of the document, the HTML anchor cooperating with a browser to display the calculated location within a displayed document.

14. The method of claim 7, further comprising storing at the server at least a portion of the document retrieved from the source server

15. A system configured to allow a user to a bookmark in an HTML document created by an author who is someone other than the user, the document being stored on a server remote from the user, comprising:
a client computer having a processor and a display;
a memory in operable communication with the processor of the client computer;
a network connection configured to enable communication between the client computer and a server remote from the client computer; and
wherein the processor of the client computer is configured to retrieve an original document created by an author other than a user of the system stored on the server remote from the client computer and display the retrieved document on the display of the client computer, the processor also configured to accept an input indicating a specific location in the displayed document from the user and to store a link containing information related to the specific location in the displayed document, the link not being added to the original document.

16. The system of claim 15, wherein the link may be used to retrieve the document from the server and display the document at the specific location of the document identified by the indication.

17. The system of claim 15, wherein the link is a virtual anchor.

18. The system of claim 15, wherein the link is a parameterized HTML URL address string.

19. The system of claim 15, wherein the link indicates a starting point and an ending point identifying a selected portion of the document.

20. The system of claim 15, wherein the hyperlink contains a link to a document viewable on the internet and locating information such that any browser with software capable of interpreting the hyperlink may navigate to a web page containing the document and use the locating information to navigate to the indicated location on the web page.
